(19) United States
(12) Patent Application Publication
(10) Pub. No.: US 2006/0190170 A1
(43) Pub. Date: Aug. 24, 2006

(54) Navigation system for vehicles

(76) Inventor: Roman Piekarz, Mielec (PL)

Correspondence Address: Jeffrey H. Kamenetsky;CHRISTOPHER & WEISBERG, P.A., Suite 2040, 200 East Las Olas Boulevard, Fort Lauderdale, FL, 33301, US

(21) Appl. No.: 11/360,074

(22) Filed: Feb. 23, 2006

(30) Foreign Application Priority Data
Feb. 23, 2005 (DE) DE102005008285.8

(51) Int. Cl. G01C 21/36

(52) U.S. Cl. 701/211; 701/200

(57) ABSTRACT

A navigation system for vehicles, including a navigation device and a unit for determination of positional data connected to the navigation device for determining the actual position of the vehicle and for transmitting this positional data to the navigation device. By utilizing a communication interface, the navigation device is capable of establishing a communication between the navigation device and a hands-free control unit for cellular phones for installation in a vehicle and for transmitting audio signals from the navigation device through the hands-free control unit to audio output means, which are connectable to the hands-free control unit.

### CROSS-REFERENCE TO RELATED APPLICATION

n/a

### STATEMENT REGARDING FEDERALLY SPONSORED RESEARCH OR DEVELOPMENT

n/a

### FIELD OF THE INVENTION

The present invention relates to a navigation system for vehicles, for example, automobiles, that includes a navigation device and a unit for determination of positional data attached to the navigation device, the unit for determining the actual position of the vehicle and for transmitting the positional data to the navigation device.

### BACKGROUND OF THE INVENTION

Navigation systems having GPS receivers for determining the position of a vehicle, which are installed within the vehicle, are well known. These systems are equipped with displays to direct the user to his or her destination using graphical symbols

German utility model DE 203 08 939, discloses a steady installed navigation system, in which its control unit is detachable from the vehicle and is designed to mate with an external display and analyzing unit, for example, a personal computer. Furthermore, it is well known to connect a holding device for a cellular phone that can be installed in a vehicle, to a previously-installed navigation system in order to show data from the cellular phone on the display of the navigation system and to control the navigation system by the installed remote control of the navigation system.

### SUMMARY OF THE INVENTION

The present invention provides an improved navigation system which can be installed in a vehicle with minimal effort. The invention provides a navigation system having a communication interface for achieving a communication connection with a hands-free car kit for use with a cellular phone in a vehicle, and for transmitting audio data signals from the navigation device over the hand-free control unit to audio output means, which are connected to the hands-free control unit.

According to one aspect of the invention, navigation system for vehicles is provided. The navigation system includes a navigation device, and a unit for determining positional data. The unit is connected to the navigation device for determining the actual position of the vehicle and for transmitting the positional data to the navigation device. The system also includes a hands-free control unit for cellular phones, means for providing an audio output, which is connectable to the hands free control unit, and a communication interface for establishing a communication between the navigation device and the hands free control unit. The communication interface transmits audio signals from the navigation device through the hands-free control unit to the means for providing an audio output.

By using the communication interface, a navigation device can easily be attached to a previously-installed hands-free control unit to conduct audio data signals, which can lead the user to his destination through the audio output means of the hands-free control unit.

A complex installation of the navigation system in the vehicle is not necessary. The communication interface is realized by an adaptor plug which has a first connector connected to the hands-free car kit and a second connector connected to a holding device for a cellular phone such that a common use of the audio input of the hands-free control unit is possible by the navigation system and the cellular phone. The adaptor plug allows an easy interposition of the navigation system between the hands-free control unit which is installed in the vehicle and the cellular phone or holding devices for the cellular phone which are installed in the vehicle.

In one embodiment of the invention, the navigation device is equipped with a power supply interface for connection to the hands-free control unit to provide service voltage for the navigation system over the hands-free car kit. The installation and fuse protection of the separate power supply for the navigation system is not necessary.

The power supply interface can be realized by an adaptor plug having a first connector for connecting a cellular telephone holding device to the power supply of the hands-free control unit, and a second connector for simultaneous connection of the navigation system and cellular phone to the power supply of the hands-free control unit. Again, the navigation system is set as an intermediary between the power supply output of the hands-free control unit and the connector for the power supply input of the cellular telephone holding devices.

The communication interface and the power supply interface are preferably construed as one adaptor plug. The navigation system can be connected to the hands-free control unit by simply attaching the adaptor plug to the hands-free control unit. The adaptor plug can be adapted for connection of a power supply, which is interconnected to the navigation system. The power supply of the cellular phone is achieved separately over the adaptor plug, which fuse protection is designed therefore. The adaptor plug and the hands-free control unit can be connected to the same power source by a splitter lead.

In another embodiment of the present invention, the communication interface is designed for the exchange of display and/or control data between the cellular phone and the navigation device. In this case, additional information like phonebook entries, short messages (SMS) etc., which are normally displayed on the cellular phone, can be displayed in a larger size on the display unit of the navigation system. In addition, by transmission of control data between the cellular phone and the navigation device, it is possible to control the cellular phone over the navigation system, and vice versa.

In another embodiment of the present invention, an adaptation of the hands-free control unit is not necessary because the communication interface is equipped with a signal converter which converts the audio data from the navigation device to the hands-free control unit in such a format that the hands-free control unit recognizes such audio data as audio data from a cellular phone. By using the signal converter, the navigation system will be simulated as a cellular phone.

In another embodiment, the navigation device is capable of generating and sending an activation signal equivalent to an activation signal of a cellular phone over the communication interface towards the hands-free control unit when the navigation device is activated. When the navigation device is activated, the hands-free control unit recognizes a simulated active cellular phone and activates itself. An adaptation of the hands-free control unit to the connector of the navigation system is not necessary.

Furthermore, the navigation device is construed to generate and send a radio mute signal via the communication interface to the hands-free control unit when audio data is transmitted from the navigation system to the hands-free control unit. By discontinuation of the radio signals, speech signals from the navigation system can be produced clearly to lead the driver of a vehicle to his destination.

The wiring effort for installation of the navigation system to the hands-free control unit can be reduced by using a wireless air link, for example, the Bluetooth® standard. The wireless air link can be designed as a communication interface to a cellular phone, holding devices for cellular phones, an adaptor plug or a hands-free control unit.

As a unit for determination of position data, a known satellite positioning unit can be used. Alternatively, or in addition, the cellular phone can be used as a unit for determining positional data. The communication interface is designed to transmit the positional data from the cellular phone to the navigation device. By using features of the cellular phone, positional data can be determined exactly by cellular radio information such as, but not limited to, radio cell identification number, field strength, and/or signal runtime etc.

Furthermore, the navigation device is construed to analyze and to screen voice data, e.g., speech commands, as control data which is transmitted via a microphone of a hands-free car kit. In this embodiment, speech control of the navigation system can be achieved by speech input and speech recognition means of the hands-free control unit.

In an embodiment of the present invention, the navigation system is equipped with a read-only device for memory devices like memory cards, compact discs (CDs), digital versatile discs (DVDs) or similar. The navigation system is capable of reading audio data from the memory device and rendering the audio data over a hands-free control unit to which audio data output means are connected. The navigation system can be used as a reproducer for audio data, such as, for example, music.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that foregoing general description and the following detailed description are exemplary and explanatory only and are not restrictive of the invention, as claimed.

### DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a block diagram of the navigation system of the present invention used in conjunction with a hands-free control unit, installed in a vehicle;

FIG. 2 is a schematic illustration of the components of the navigation system of the present invention used in conjunction with a hands-free car kit installed in a vehicle; and

FIG. 3 is a schematic illustration of the navigation system of the present invention including a power supply connector connected to a power supply source via an adaptor plug.

### DETAILED DESCRIPTION OF THE INVENTION

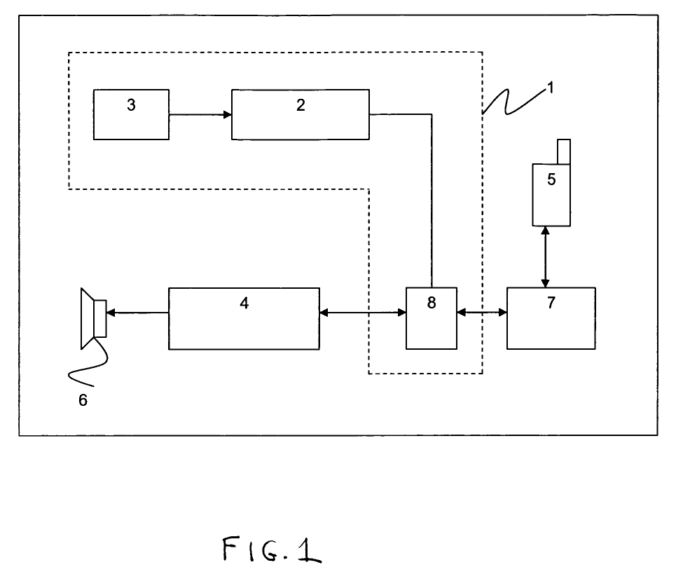

FIG. 1 shows a block diagram of a navigation system 1 with a common navigation device 2 which leads the driver to an entered destination. Therefore, the navigation device 2 is connected to a unit for determination of position data 3 in a vehicle, for example, a Global Positioning System (GPS) receiver, to determine the actual position of the vehicle and to transmit positional data to navigation device 2 for further use.

A hands-free car kit with a hands-free control unit 4, is installed in the car, which is construed to render audio data from at least one cellular phone 5 over at least one connected audio output means 6. Audio output means 6 could be, but is not limited to, a car stereo system or a loudspeaker.

As an adaptor for the cellular phone 5, a holding device 7 is installed in the vehicle, and is attached to the hands-free control unit 4, via a cable and a connector. The navigation system 1 can be equipped with further known devices such as, but not limited to, display units, remote controls or the like. Furthermore, the hands-free control unit 4 can be equipped with additional devices like an external microphone. In FIG. 1, only the relevant elements of the invention are shown.

An adaptor plug 8 is intended to be set as intermediary between a communication interface and/or a power supply interface of a hands-free control unit 4 and a holding device 7 for cellular phone 5. In that way, it is possible to at least transmit audio data from the navigation device 2 over the hands-free control unit 4 to audio output means 6. For this purpose, the navigation device 2 and/or the adaptor plug 8 can be designed with a signal converter to provide signals to the hands-free control unit 4 which are equivalent to signals from the holding device 7 of the cellular phone 5. Thus, the navigation system 1 will be recognized by the hands-free control unit 4 as a cellular phone 5 or as a holding device 7 for a cellular phone 5.

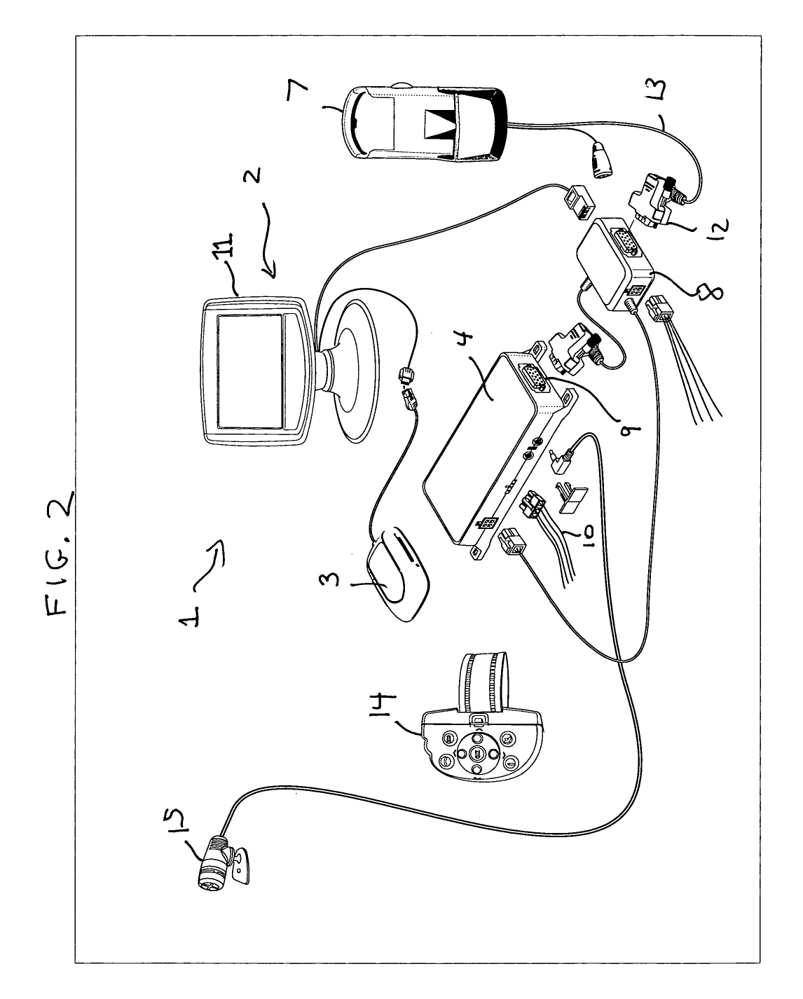

FIG. 2 shows a perspective view of the components of the navigation system 1 and a hands-free car kit. Navigation system 1 can be easily expanded by using the adaptor plug 8 at the communication input/output connector 9 of holding device 7 of the hands-free car kit, which is already installed within the vehicle. The adaptor plug 8 transmits at least the audio data from the navigation device 2 to the hands-free control unit 4 to use the audio output means 6 which is already connected to the hands-free control unit 4 with an audio signal connector 10.

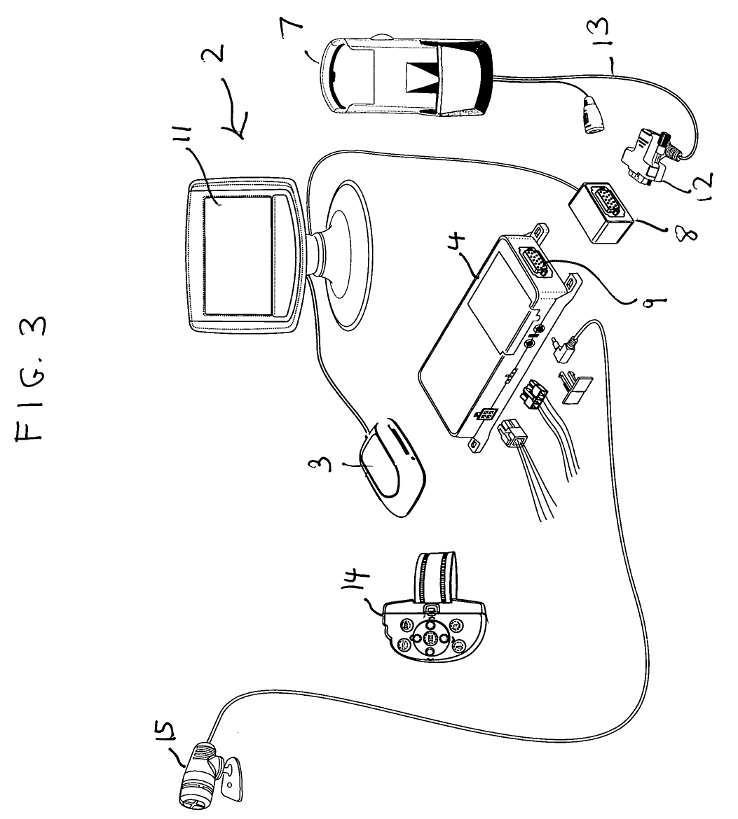

The service voltage of the navigation system 1 can be provided over the adaptor plug 8, or over an additional power supply interface connected to the hands-free control unit 4. In this embodiment, an additional separate bus bar and fuse protection device for the navigation system is not necessary. As shown in FIG. 3, it is possible to use a splitter lead connecting the hands-free control unit 4 and the adaptor plug 8 with a power source. The navigation system 1 will receive service voltage directly from the power source, and the hands-free car kit will receive service voltage through a fuse protected hands-free control unit 4. The adaptor plug 8 may be designed with one of any type of power supply connector.

The unit for determination of position data 3 in the form of a GPS antenna is connected to the navigation device 2 via a cable. This unit 3 provides positional data for the navigation device 2. Navigation device 2 is equipped with a display unit 11 which functions as a media display for data from a cellular phone 5 (not shown in FIG. 3) inserted into holding device 7. The adaptor plug 8 serves as a communication interface to the cellular phone 5 over a connector 12 and the assigned signal line 13 of the holding device 7. In this manner, the navigation device 2 is able to display, for example, short messages (SMS), different phone numbers, incoming calls, phonebook entries, etc. During navigation, directional assignments are displayed on the display unit 11 as icons or pictograms.

Another function of the navigation device 2 can be achieved by a read-only device for memory devices such as compact flash cards. Audio data, for example, mp3 music data, can be read by the navigation device 2 and rendered over audio output means 6 of the hands-free control unit 4. For this purpose, the hands free control unit 4 can be modified with at least two audio outputs, for stereo quality.

Furthermore, in one embodiment, an infrared remote control 14 is provided. Control 14 can be attached to, for example, the steering wheel of a vehicle, and is equipped with photosensitive photocell. The navigation device 2 can be equipped with such a photosensitive photocell to automatically dim the display unit 11 in the dark. By use of a photocell, use of the infrared remote control 14 with which the navigation system 1 as well as the hands-free car kit can be controlled, should be safer in the dark. Through this configuration, an automatic illumination of the buttons of the infrared remote control 14 is realized. The illumination of the buttons of the infrared remote control 14 is activated by pushing a button of the infrared remote control 14. Instead of an infrared remote control 14, a corresponding system can be developed with radio, ultrasonic etc. A timer of, for example, five seconds in duration, will keep the illumination activated and, after that period of time, will deactivate the illumination to save energy.

To use the signals from the navigation system 1 and the signals from the hands-free car kit simultaneously, the adaptor plug 8 is plugged between the connector 9 of the hands-free control unit 4 and the connector 12 of the holding device 7. Signals from the hands-free control unit 4 to the holding device 7 could represent, for example, screened, on-board vehicle power supply voltage, ignition signals, or a standardized symmetric microphone signal of a microphone connected to the hands-free control unit. Signals from the holding device 7 to the hands-free control unit could be, but are not limited to, standardized symmetric audio receiving signals, signal lines indicating that a cellular phone is connected to the holding device 7, audio activation signals, radio mute signals, and/or deactivation signals for the hands-free control unit 4.

Transmitted signals from the navigation device 2 over the adaptor plug 8 to the hands-free control unit 4 could be, but are not limited to, standardized symmetric audio signals of navigation assignments, audio activation signals, and/or acknowledgement signals from the activated navigation system 1. Signals from the navigation device 2 to the holding devices 7 and vice versa could be, but are not limited to, TXD, serial broadcasting lines, and/or RXD, serial reception lines.

The adaptor plug 8 includes a signal converter to mix the signals of the navigation device 2 such that the navigation system 1, as well as the hands-free control unit 4, can be utilized at the same time. The signal converter converts the signals into a simulated phone connection for the hands-free control unit 4. In this case, a signal indicating that a cellular phone 5 has been inserted into the holding device 7 is generated when the navigation system 1 is activated. This signal will be sent to the hands-free control unit 4. The hands-free control unit 4 recognizes the navigation system 1 as a cellular phone 5 that is inserted into holding device 7. When the navigation device 2 gives an audio output over the communication interface, an active phone call will be simulated and the audio output amplifier of the hands-free control unit 4 will be activated. The stereo system connected to the hands-free control unit 4, which serves as audio output means 6, will be muted for the output of audio data from navigation device 2.

After the navigation device 2 has detected that the ignition has been switched off, by analyzing the ignition signal of the vehicle, navigation device 2 switches itself off after a predetermined period of time. After receipt of an “ignition off” signal, navigation device 2 switches off after a predetermined period of time. The hands-free car unit 4 shuts down as well.

If signals from the holding device 7 for the cellular phone 5 and signals from the navigation system 1 arrive at the hands-free control unit 4 at substantially the same time, certain conditions may apply. For example, after an indication that the ignition signal is “on,” the hands-free control unit 4, will be switched on, if navigation system 1 is activated or a cellular phone 5 is inserted into the holding device 7. In another example, after an indication that the ignition signal is “off”, the hands-free control unit 4 will be switched off, if navigation system 1 and the holding device 7 for a cellular phone 5 are deactivated. In yet another example, if a navigation assignment occurs during an active phone call, both audio signals will be transmitted to the connected audio output means 6. In still another example, the radio will be muted if the holding device 7 for a cellular phone 5 or the navigation device 2 generates the corresponding signal (radio mute signal).

In addition to the common functions of a hands-free car kit, the combination of navigation system 1 and hands-free car kit allows the operation of the cellular phone 5 with a specific menu of the navigation system 1. For this function, a data connection between the cellular phone 5 and the navigation device 2 will be realized over the adaptor plug 8 and a communication interface of the navigation device 2. The following are functions that can be achieved over the data connection. One function could be the reading of different phone books from the cellular phone 5 or from a SIM card of the cellular phone 5. Another function is the reading of short messages (SMS) and the displaying of these messages on display means 11 of the navigation system 1. Still another functional example is the reading of the phone status including field strength and battery charging status and displaying this information on display means 11 of the navigation device 2. Other exemplary functions include dialing a phone number using input means of the navigation system 1, receiving information relating to outgoing and incoming calls by the navigation device 2, and accepting, terminating and rejecting calls using input means of the navigation system 1.

A communication protocol used by the communication interface can be adapted to cellular phones 5 of different kinds. To do so, the navigation device 2 is designed to identify the type of cellular phone 5 inserted into the holding device 7 and to select the corresponding communication protocol. The communication protocol can differ by such parameters as type and manufacturer of cellular phone 5.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

What is claimed is:

1. A navigation system for vehicles comprising:
a navigation device;
a unit for determining positional data connected to the navigation device, the unit for determining actual position of the vehicle and for transmitting said positional data to the navigation device;
a hands-free control unit for cellular phones;
means for providing an audio output connectable to the hands-free control unit; and
a communication interface for establishing a communication between said navigation device and the hands-free control unit, wherein the communication interface transmits audio signals from the navigation device through the hands-free control unit to the means for providing an audio output.

2. The navigation system in accordance with claim 1, wherein said communication interface includes:
a holding device for holding the cellular phone; and
an adaptor plug attachable between the hands-free control unit and the holding device such that said navigation system and said cellular phone can use an audio signal input of said hands free control unit.

3. The navigation system in accordance with claim 1, wherein said navigation device is equipped with a power supply interface connectable with the hands-free control unit to supply said navigation system with service voltage.

4. The navigation system in accordance with claim 3, wherein the power supply interface comprises the adaptor plug which is attached between the hands-free control unit and the holding device, the adaptor plug establishing a first connection to the power supply of the hands free control unit at one end, and a second connection for simultaneously providing service voltage to the navigation system and the cellular phone over the hands-free control unit.

5. The navigation system in accordance with claim 3, wherein said communication interface and said power supply interface comprise one adaptor plug.

6. The navigation system in accordance with claim 2, wherein said adaptor plug has a connection to a power supply source and provides a service voltage to the navigation system over said connection and wherein the service voltage of the cellular phone is separately provided from the hands-free control unit over the adaptor plug.

7. The navigation system in accordance with claim 1, wherein said communication interface is designed to exchange signalling data and/or control data between the cellular phone and the navigation device.

8. The navigation system in accordance with claim 7, wherein said navigation device is equipped with display means and said navigation device is designed to display the signalling data of the cellular phone on said display means.

9. The navigation system in accordance with claim 7, wherein the navigation device is capable of converting the control data from the cellular phone.

10. The navigation system in accordance claim 1, wherein the communication interface is equipped with a signal converter which converts the audio signals of the navigation device such that the hands-free control unit recognizes said audio signals as audio signals of the cellular phone.

11. The navigation system in accordance with claim 10, wherein the navigation device is capable of generating and sending an activation signal of the cellular phone over the communication interface to the hands-free control unit when said navigation device is activated.

12. The navigation system in accordance with claim 1, wherein the navigation device is capable of generating and sending a radio mute signal over the communication interface to the hands-free control unit when the audio signals are transmitted from said navigation system to the hands-free control unit.

13. The navigation system in accordance with claim 2, wherein the communication interface is as a wireless link.

14. The navigation system in accordance to claim 13, wherein the wireless link is designed to communicate with the cellular phone, the holding device for the cellular phone, the adaptor plug, or the hands-free control unit.

15. The navigation system in accordance with claim 1, wherein the unit for determining positional data is a satellite positioning unit.

16. The navigation system in accordance with claim 1, wherein the unit for determining positional data is the cellular phone and the communication interface is designed to transmit the positional data from the cellular phone to the navigation device.

17. The navigation system in accordance with claim 7, further comprising a microphone, wherein the navigation device is designed to analyze and to achieve speech commands which are inputted over the microphone, wherein said speech commands represent the control data.

18. The navigation system in accordance with claim 1, wherein said navigation system further comprises means for reading memory devices, said navigation system designed to read the audio signals from said memory devices and to transmit said audio signals over the hands-free control unit through the audio output means, said audio output means connected to said hands-free control unit.
